(19) United States
(12) Patent Application Publication
(10) Pub. No.: US 2008/0147716 A1
(43) Pub. Date: Jun. 19, 2008

(54) INFORMATION NERVOUS SYSTEM

(76) Inventor: Nosa Omoigui, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/931,659

(22) Filed: Oct. 31, 2007

Related U.S. Application Data
(63) Continuation of application No. 11/127,021, filed on May 10, 2005.
Application No. 11/127,021 is a continuation-in-part of application No. 10/179,651, filed on Jun. 24, 2002, now abandoned.
(60) Provisional application No. 60/569,663, filed on May 10, 2004.
(60) Provisional application No. 60/569,665, filed on May 10, 2004.
(60) Provisional application No. 60/360,610, filed on Feb. 28, 2002.
(60) Provisional application No. 60/300,385, filed on Jun. 22, 2001.

(30) Foreign Application Priority Data
Feb. 14, 2004 (US) PCT/US04/04574
Feb. 17, 2005 (US) PCT/US05/05329

(51) Int. Cl. G06F 17/30

(52) U.S. Cl. 707/102; 707/E17.005

(57) ABSTRACT

The present invention is directed to a framework or medium for knowledge retrieval, management, delivery and/or presentation. The system maintains semantic information and other knowledge to provide retrieval services to clients via a communication medium. Within the system, objects or events in a hierarchy are semantically related to each other, and agents implementing queries return data objects for presentation to the client according to a semantically influenced or determined theme. This system provides various means for the client to customize agents and/or the underlying related queries to optimize the presentation of the resulting information.

### COPYRIGHT NOTICE

This disclosure is protected under United States and International Copyright Laws.© 2002-2007 Nosa Omoigui. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to computers and, more specifically, to information management and research systems.

### BACKGROUND OF THE INVENTION

The following application is incorporated by reference as if fully set forth herein: U.S. application Ser. No. 11/127,021 filed May 10, 2005. Preferred embodiments of the present invention are directed in part to a semantically integrated knowledge retrieval, management, delivery and/or presentation system. Preferred embodiments of the present invention and system include several additional improved features, enhancements and/or properties, including, without limitation, semantic advertisements, spider RSS integration, pivot views, watch lists, context extraction methods, context ranking methods, client duplication management methods, a server data and index model, improved metadata indexing methods, adaptive ranking methods, and content transformation methods.

### BRIEF DESCRIPTION OF THE DRAWINGS

The preferred and alternative embodiments of the present invention are described in detail below with reference to the following drawings.

FIG. 1 is a block diagram of a method for implementing semantic advertisements in an internet browser.

FIG. 2 is a block diagram of a method for integrating HTTP metadata and RSS metadata in an information server.

FIG. 3 is a block diagram of a method for dynamically making input suggestions based upon prior user input.

FIG. 3 is a block diagram of a method for dynamically making input suggestions based upon prior user input.

FIG. 4 is a block diagram of a method for presenting time sensitive information to a user.

FIG. 5 is a block diagram for a method of presenting knowledge community statistics at a client user interface, in accordance with an embodiment of the invention.

FIG. 6 is a screen shot of a client user interface presenting statistics, in accordance with an embodiment of the invention.

FIG. 7 is a block diagram of a method for allowing users to remove duplicative presented information.

FIGS. 8A-8B illustrate a documents table data and index model, in accordance with an embodiment of the invention.

FIG. 9 is an objects table data and index model, in accordance with an embodiment of the invention.

FIG. 10 is a semantic links table data and index model, in accordance with an embodiment of the invention.

FIG. 11 is a composite index table model, in accordance with an embodiment of the invention.

FIG. 12 is a block diagram for a method of quickly indexing data contained in a metadata feed, in accordance with an embodiment of the invention.

FIG. 13 is a block diagram for a method of adjusting threshold values that are used to determine the most relevant objects in a given context, in accordance with an embodiment of the invention.

FIG. 14 is a method for indexing and retrieving semantically relevant documents, in accordance with an embodiment of the invention.

FIG. 15 is a method for highlighting semantically relevant keywords in displayed documents resulting from semantic searches, in accordance with an embodiment of the invention.

FIG. 16 is an example of the highlighted document displayed as a result of the process in FIG. 15.

FIG. 17 is a block diagram showing methods for creating and managing multiple types of knowledge communities, in accordance with an embodiment of the invention.

FIG. 18 is a screen shot showing a possible implementation of the embodiment shown in FIG. 17 and described above.

FIG. 19 is a block diagram of a method for providing user feedback on the available knowledge communities, in accordance with an embodiment of the invention.

FIG. 20 is a screen shot showing a possible implementation of the embodiment shown in FIG. 19 and described above.

FIG. 21 illustrates a method of using semantic sounds to notify a user regarding the arrival of news in accordance with an embodiment of the invention.

FIG. 22 is a method of tracking and presenting multiple lists of categories to a client user as the categories evolve over time, in accordance with an embodiment of the invention.

FIG. 23 is a block diagram of a method of semantically indexing and retrieving non-text data, in accordance with an embodiment of the invention.

FIG. 24 is a block diagram of a method for providing ontology feedback in accordance with an embodiment of the invention.

FIG. 25 is a block diagram of a method for advanced semantic searching in accordance with an embodiment of the invention.

FIG. 26 is a block diagram of a method for handling floating text in an RSS feed.

FIG. 27 is an example of an RSS in FIG. 26 with a namespace qualified tag indicating the absence of a stored file in accordance with an embodiment of the invention.

FIG. 28 is a block diagram of a method for extracting a semantic query from an image, in accordance with an embodiment of the invention.

FIG. 29 is a block diagram for a method for improving ontology development in accordance with an embodiment of the invention.

FIG. 30 is a block diagram of a method for developing and maintaining ontologies, in accordance with an embodiment of the invention.

FIG. 31 is a block diagram for a method for semantic question answering in accordance with an embodiment of the invention.

FIG. 32 is a block diagram of a method of coupling natural language with semantic language queries in accordance with an embodiment of the invention.

FIG. 33 is a block diagram of a method for categorizing extracted concepts from a URI, in accordance with an embodiment of the invention.

FIG. 34 is a block diagram of a method for establishing context queries, in accordance with an embodiment of the invention.

FIG. 35 is a block diagram of a method for extracting concepts from disparate sources, in accordance with an embodiment of the invention.

FIG. 36 is a block diagram of a method for re-organizing independent website data according to semantic strength, in accordance with an embodiment of the invention.

FIG. 37 is a block diagram of a method for semantic analysis on the client, in accordance with an embodiment of the invention.

FIG. 38 is a block diagram for a method of generating information on experts, interest groups, or newsmakers, in accordance with an embodiment of the invention.

FIG. 39 is a method for adding new ontologies to a client semantic browser, in accordance with an embodiment of the invention.

FIG. 40 illustrates a method for using field and category specific searches to supplement keyword searches, in accordance with an embodiment of the invention.

FIG. 41 is a method for creating weighted indices and searching thereon, in accordance with an embodiment of the invention.

### DETAILED DESCRIPTION OF THE PREFERRED EMBODIMENT

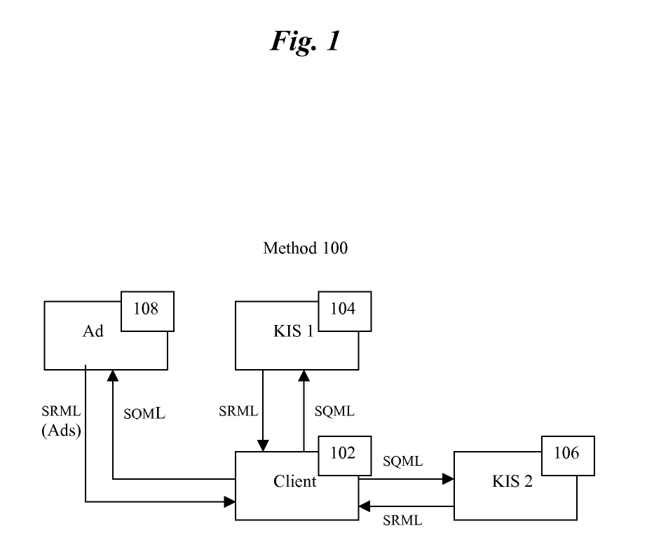

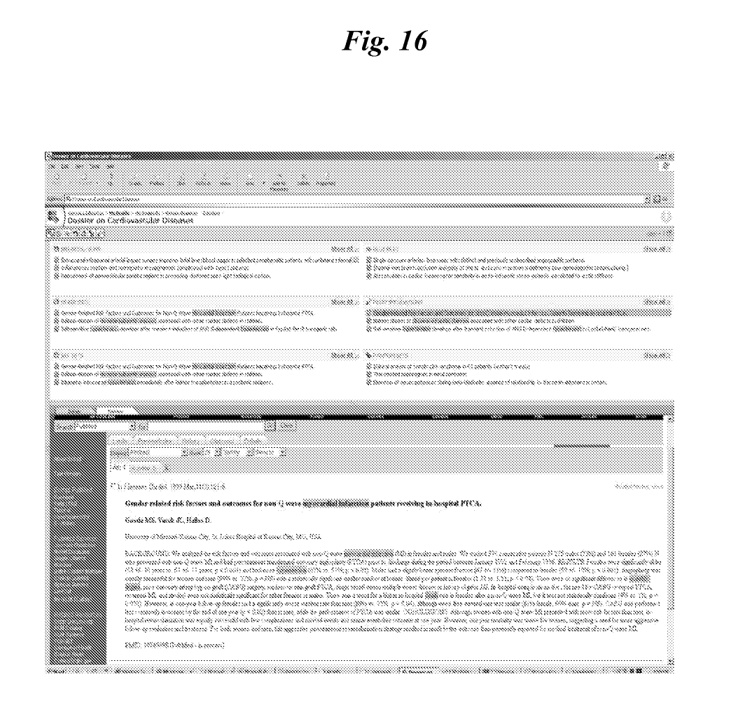

The present invention relates to computers and, more specifically, to information management and research systems. Specific details of certain embodiments of the invention are set forth in the following description and in FIGS. 1-41 to provide a thorough understanding of such embodiments. In one embodiment, the system incorporates not only the features and functions described in my parent application, but also at least some of the additional features, enhancements and/or properties described in this application. The present invention may have additional embodiments, or may be practiced without one or more of the details described for any particular described embodiment.

FIG. 1 is a block diagram of a method for implementing semantic advertisements in an internet browser, in accordance with an embodiment of the invention. In one embodiment, the browser 102 is in communication with an information server 104, an information server 106, and an advertisement generating service 108. The browser 102 may be in communication with additional or fewer information servers as well as additional advertisement generating services. These servers may be located on a single piece of hardware or on multiple hardware components both locally or separated by distances. In one embodiment, semantic ads in the invention are implemented by integrating a client 102 with an advertisement generating service 108. The advertisement generating service 108 may be independently operated or part of the overall invention. Furthermore, the advertisement generating service 108 may be located on the internet or located on an intranet. In another embodiment, the advertisement generating service 108 hosts advertisements. The user of browser 102 invokes a query and that is submitted to the advertisement generating service 108. In one embodiment, the query from browser 102 is also sent to information server 104 or 106 to obtain content. The advertisement generating service 108 then accepts and interprets the incoming query request and responds with advertisements that are semantically relevant to the query request. In one embodiment, the advertisement generating service 108 functions similar to the systems for returning semantically relevant content results disclosed in the parent application. In this embodiment, one difference is that the advertisement generating service 108 returns semantically relevant advertisements rather than semantically relevant content results. As an example, a query for “data mining and security” information may result in the advertisement generating service 108 returning advertisements on data mining and security. However, the advertisement generating service 108 may also return other advertisements that are semantically relevant such as advertisements on data searching and encryption, SQL and firewalls, or other similar results. In one embodiment, advertisements are delivered from the advertising generating service 108 or displayed in the browser 102 based on semantic strength or the degree of relevance to the query. However, the advertisements may be delivered from the advertisement generating service 108 or displayed in the browser 102 based in lieu of or in addition to semantic relevance, including the categories or context distinctions disclosed in the parent application. Categories may include, but are not limited to, advertisements on breaking news on the query, advertisements from experts on the query, advertisements regarding interest groups on the query, advertisements based on popularity, most recent advertisements regarding the query, recommended advertisements based on the query, advertisements in headlines based on the query, or may simply be random advertisements. In another embodiment, the advertisements are delivered or displayed based upon the price paid for the advertising service. Context distinctions may include, but are not limited to, advertisements of people, events, documents, topics, books, products, projects, texts, file-shares, distribution lists, blobs, images, local file folders, or any other context. In an alternative embodiment, the browser 102 presents the advertisements in a side panel, on part of the browser, on the whole browser, and the advertisements may be stationary, moving, or dynamically updated.

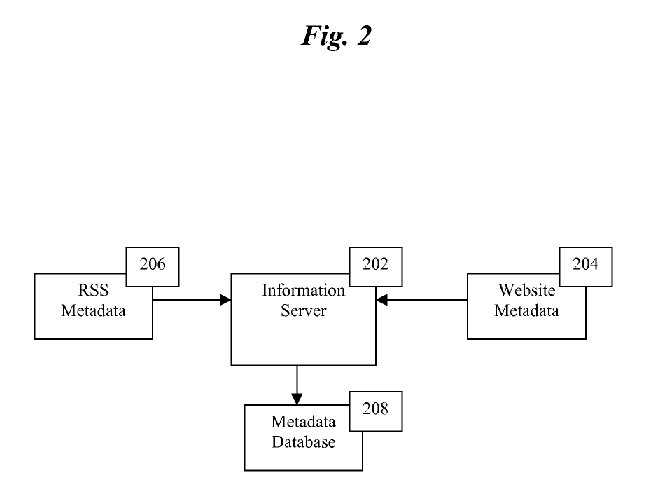

FIG. 2 is a block diagram of a method for integrating HTTP metadata and RSS metadata in an information server, in accordance with an embodiment of the invention. In one embodiment of the invention, an information server 202 is in communication with a website 204 and an RSS feed 206 wherein the information server 202 collects metadata from both sources and stores it in a metadata database 208. The invention is not limited to an RSS feed, but may include any equivalent or alternate source of metadata. Furthermore, the invention may involve multiple websites and RSS feeds. In another embodiment, the information server 202 solicits metadata from the website 204. Information server 202 then stores the resulting metadata in the metadata database 208. In yet another embodiment, the information server 202 solicits metadata from an RSS feed 206. Information server 202 then stores the resulting metadata in the metadata database 208. In one embodiment, the information server 202 detects an RSS feed 206 while crawling websites 204. In another embodiment, RSS metadata from the RSS feed 206 complements website metadata from website 204 in the metadata database 208. Alternatively, RSS metadata from the RSS feed 206 replaces the website metadata from website 204 in the metadata database 208. In a further embodiment, RSS metadata from RSS feed 206 is organized using XML. In this embodiment, the information server 202 validates the RSS feed using an XML schema. In an alternative embodiment, the metadata in the metadata database 208 is indexed according to the URI from which the metadata originated.

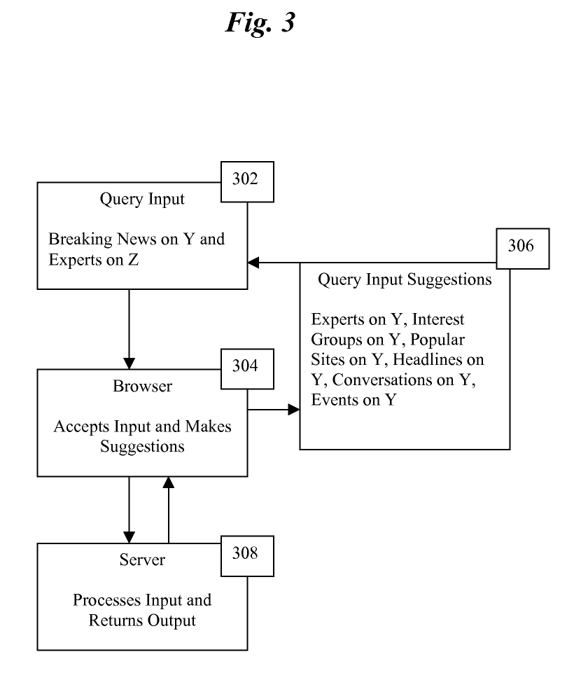

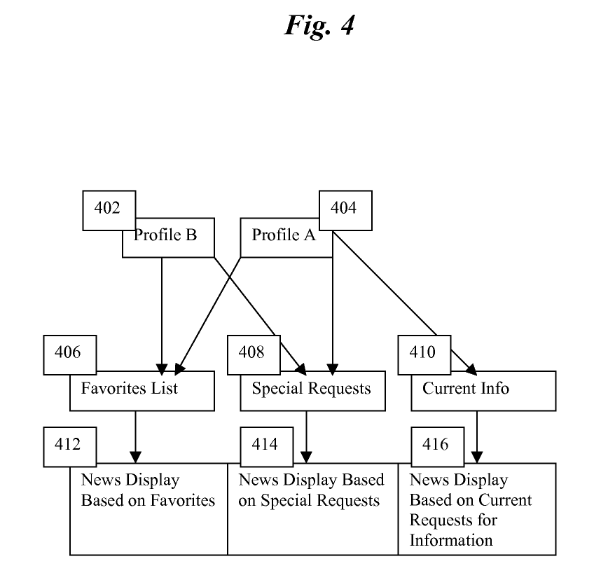

FIG. 3 is a block diagram of a method for dynamically making input suggestions based upon prior user input, in accordance with an embodiment of the invention. In one embodiment, a browser 304 accepts input from the query input 302 and is in communication with a server 308. The browser 304 provides feedback in the form of suggestions for additional queries at block 306.

In another embodiment, the query input 302 is a request for breaking news on Y and experts on Z. However, the query may be any query, including, without limitation, those disclosed in the parent application. In this embodiment, the browser 304 accepts the query input 302 and browser 304 satisfies the query request with information from the server 308. However, in one embodiment, the browser 304 also offers query suggestions 306 based upon the query input at 302. Query suggestions 306 based upon the query input 302 of breaking news on Y and experts on Z may include, but are not limited to experts on Y, interest groups on Y, popular sites on Y, headlines on Y, conversations on Y, events on Y, breaking news on Z, interest groups on Z, popular sites on Z, headlines on Y, conversations on Y, or events on Y. In a further embodiment, the query input 302 is modified and submitted to browser 304 based upon the query suggestions 306.

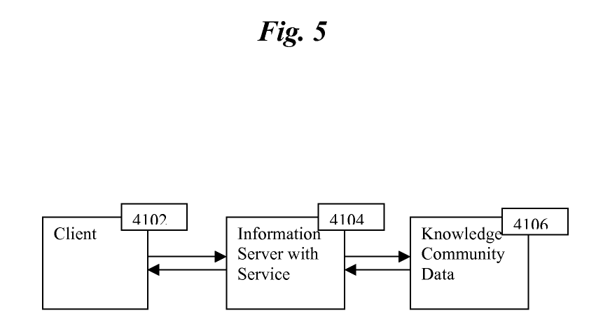

FIG. 4 is a block diagram of a method for presenting time sensitive information to a user, in accordance with an embodiment of the invention. In one embodiment, information from a favorites list 406, special requests 408, or current information 410 is obtained from profile A 404. This information is used to present time sensitive information to the user from news display 412, 414, or 416. In an alternative embodiment, information from favorites list 406, special requests 408, or current information 410 is obtained from other profiles such as profile B 402. This information may also be used to present time sensitive information to the user from news display 412, 414, or 416. These and many other profiles may be used to obtain information.

In another embodiment, the news display 412 content is inferred or deduced automatically from a favorites list 406 of a particular profile such as profile A 404. For example, the favorites list 406 of profile A 404 may contain Experts on X, Best Bets on X, Favorite Website on Y, or any other favorite topic from any context. In this embodiment, news display 412 presents information on News on X or News on Y. In another, the news display 412 removes duplicate entries. In one embodiment, news display 412 present similar information based on the favorites list 406 of profile B 402. This information may be presented in news display 412 together with or separate from information originating from profile A 404.

In yet another embodiment, the invention accepts custom requests for news information from a user under a profile such as profile A 404 at block 408. The custom requests for news information at block 408 may also be accepted under different profiles such as profile B 402. In one embodiment, news display 414 presents news information to the user based on special requests 408. News display 414 may therefore present news information for special requests 408 for a single profile or multiple profiles. Furthermore, news display 414 may segregate news information presented based on the originating profile that submitted the special request 408.

In yet another embodiment, news display 416 presents news information based on the current information 410. The current information 410 generally refers to the information that a user is currently viewing. In one embodiment, the news display 416 will not present duplicative information that is already accessible by the user or presented to the user. News displays 412 and 414 may also be adapted to remove duplicative information.

In a further embodiment, news displays 412, 414, or 416 present breaking news, headlines, and/or newsmakers information for each topic. For example, in this embodiment, news display 412 is based on the favorites list 406 from profile A 404, which contains a link to experts on X, and may present breaking news on X, headlines on X, and/or newsmakers on X. This could be true for every topic, from every profile, and under any news display 412, 414, and 416.

In an alternative embodiment, the news displays 412, 414, or 416 may be static, dynamic, animated, or scrollable. Furthermore, the news displays 412, 414, or 416 may be presented together or separate on a portion of the display screen, on the entire display screen, or on multiple display screens.

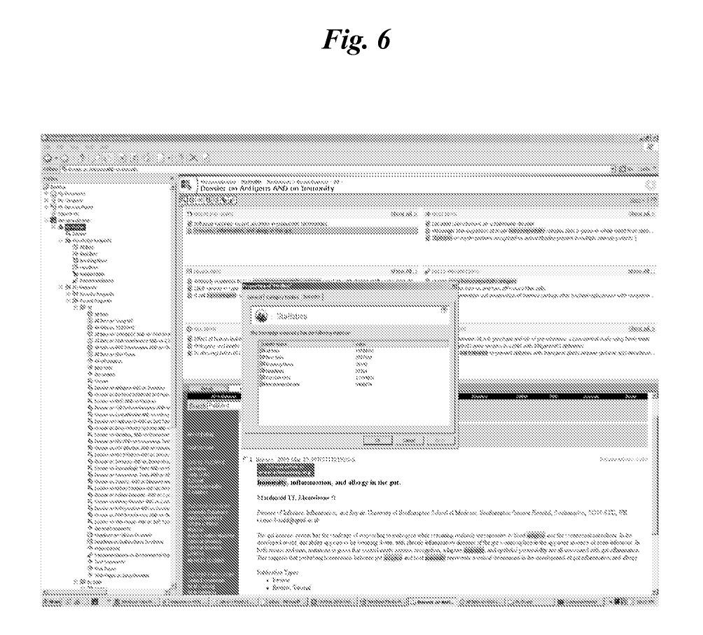

FIG. 5 is a block diagram for a method of presenting knowledge community statistics at a client user interface, in accordance with an embodiment of the invention. In one embodiment, a client invokes a request for statistics on one or more knowledge communities at block 4102. The request is brokered by an information server at block 4104. The information server requests statistics from one or more knowledge communities at block 4106. The statistics are returned directly to the client at block 4102 or through the information server at block 4104. In another embodiment, the statistics include results count per context-template. Alternatively, any statistics on any data from any part of the invention may be presented.

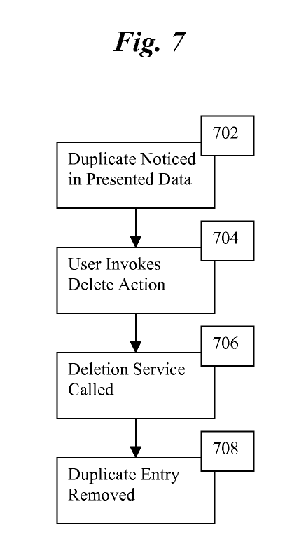

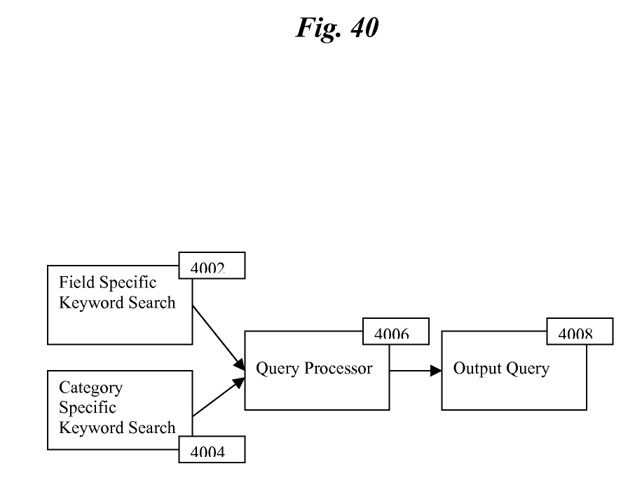

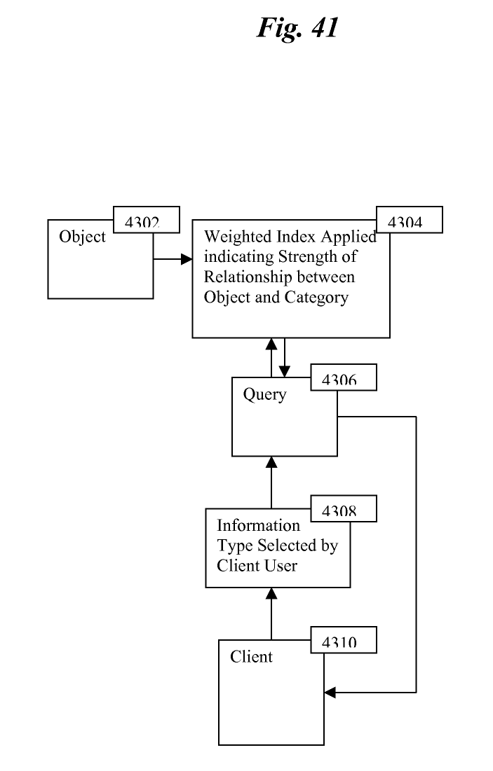

FIG. 6 is a screen shot of a client user interface presenting statistics, in accordance with an embodiment of the invention. (See, also, FIGS. 40 and 41 and corresponding description below).

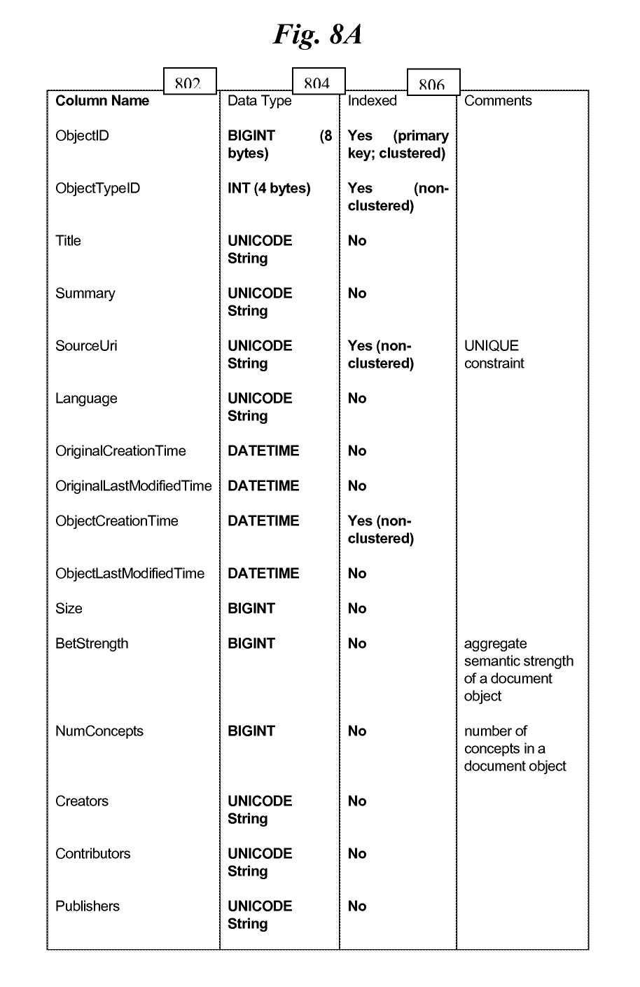

FIG. 7 is a block diagram of a method for allowing users to remove duplicative presented information, in accordance with an embodiment of the invention. In one embodiment, duplicative information is presented to the user and noticed by the user at block 702. The user manifests an intent to delete the duplicative information at block 704 by triggering a command. The command may invoke a deletion service at block 706 thereby removing the duplicative entry at block 708.

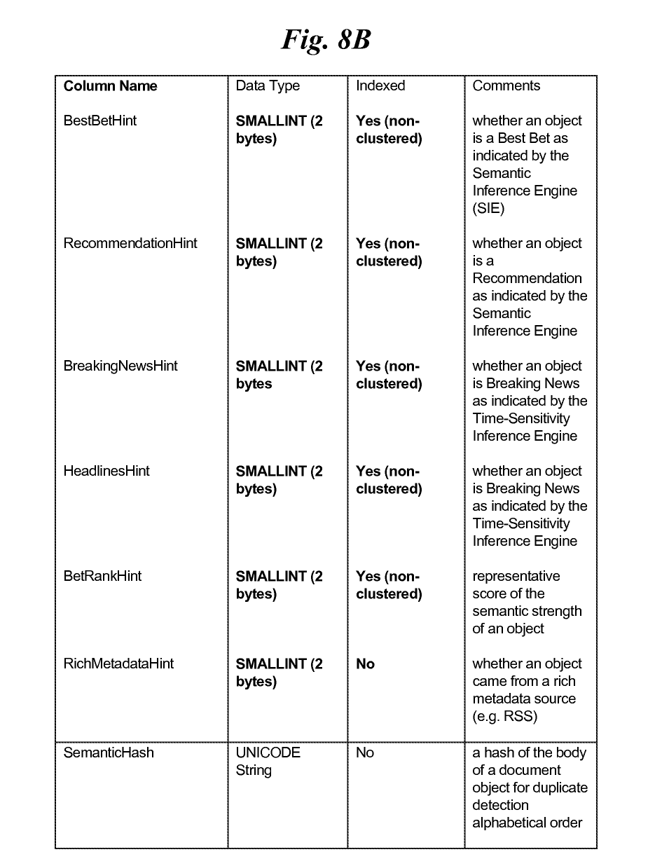

FIGS. 8A-8B illustrate a documents table data and index model, in accordance with an embodiment of the invention. In one embodiment, the documents table includes the fields listed under the column name 802. One or more of the fields and/or the field names under the column name 802 may be changed, added, and/or removed and still be within the teachings of this invention. Preferably, each field listed under column name 802 may have a corresponding data type listed in the data type column 804. The examples provided in the data type column 804 may be deviated from and still be within the scope of this invention. Each field listed under column name 802 may be indexed as indicated in the indexed column 806. However, other fields listed under column name 802 may be indexed and fields shown as indexed in the indexed column 806 may be non-indexed.

In another embodiment, the SourceUri field is a unique constraint. In yet another embodiment, the BetStrength field indicates the aggregate semantic strength of the document. In a further embodiment, the NumConcepts field indicates the number of concepts in the document. In yet a further embodiment, the BestBetHint field indicates whether a particular object is a best bet as indicated by the semantic inference engine previously disclosed in applicant's prior applications, referenced above. In an alternative embodiment, the recommendationHint field indicates whether a particular object is a recommendation as indicated by the semantic inference engine. In one embodiment, the default for this field is two-thirds of the best bet semantic strength value. In another embodiment, the BreakingNewsHint indicates whether a particular object is breaking news as indicated by the time sensitive inference engine previously disclosed in prior applications. In a further embodiment, the HeadlinesHint field indicates whether a particular object is breaking news as indicated by the time sensitive interface engine. In yet a further embodiment, the BetRankHint field represents the score of a particular object's semantic strength. In an alternative embodiment, the RichMetadataHint field indicates whether a particular object originated from a rich metadata source. In another embodiment, the SemanticHash field represents a hash of the body of a particular document object to enable duplication detection. For example, the hash may include the key phrases of a document in alphabetical order.

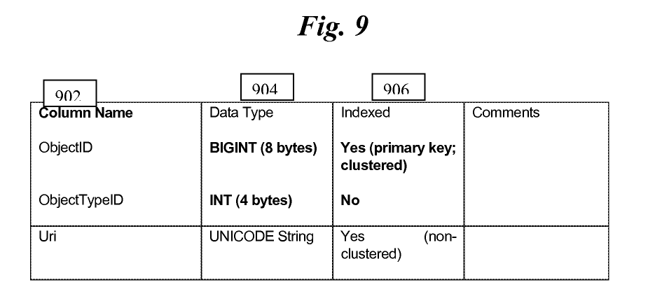

FIG. 9 is an objects table data and index model, in accordance with an embodiment of the invention. In one embodiment, the objects table includes the fields listed under the column name 902 column. The field names under the column name 902 may be changed, added, or removed and still be within the teachings of this invention. Preferably, each field listed under column name 902 will have a corresponding data type listed in the data type column 904. The examples provided in the data type column 904 may be deviated from and still be within the scope of this invention. Each field listed under column name 902 may be indexed as indicated in the indexed column 906. However, other fields listed under column name 902 may be indexed and fields shown as indexed in the indexed column 906 may be non-indexed.

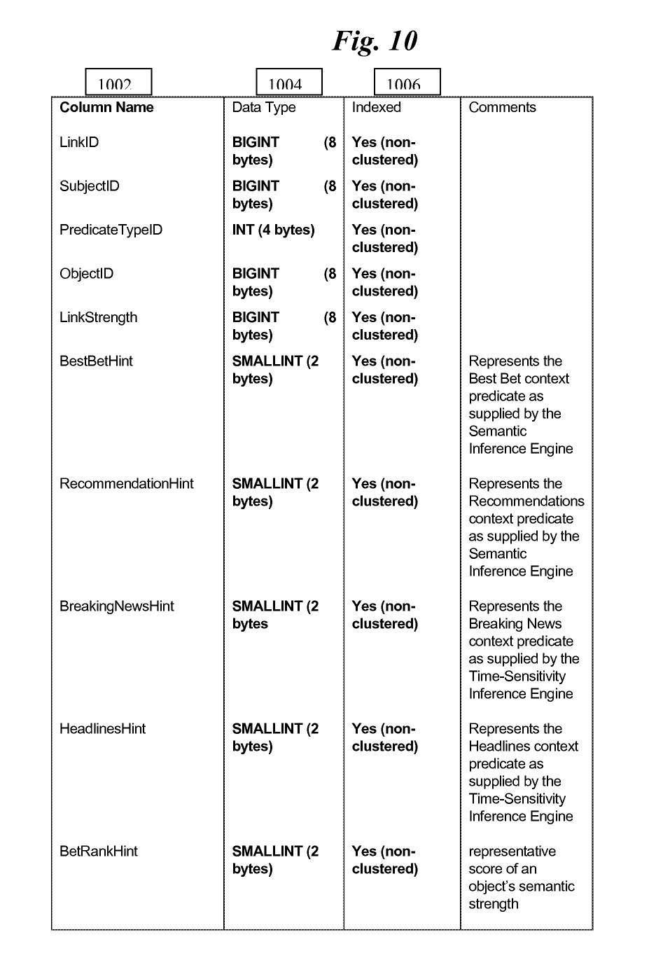

FIG. 10 is a semantic links table data and index model, in accordance with an embodiment of the invention. In one embodiment, the semantic links table includes the fields listed under the column name 1002. The field names under the column name 1002 may be changed, added, or removed and still be within the teachings of this invention. Each field listed under column name 1002 may have a corresponding data type listed in the data type column 1004. The examples provided in the data type column 1004 may be deviated from and still be within the scope of this invention. Each field listed under column name 1002 may be indexed as indicated in the indexed column 1006. However, other fields listed under column name 1002 may be indexed and fields shown as indexed in the indexed column 1006 may be non-indexed.

In one embodiment, the BestBetHint field represents the best bet context predicate as supplied by the semantic inference engine. In another embodiment, the RecommendationHint field represents the context predicate as supplied by the semantic interface engine. Additionally, its default value may be two-thirds (or any other fraction in alternate embodiments) of the best bet semantic strength value. In a further embodiment, the BreakingNewsHint field represents the breaking news context predicate as supplied by the time sensitive inference engine. In an alternative embodiment, the HeadlinesHint field represents the headlines context predicate as supplied by the time sensitive inference engine. In yet another embodiment, the BetRankHint field represents the score of the semantic strength of a particular object.

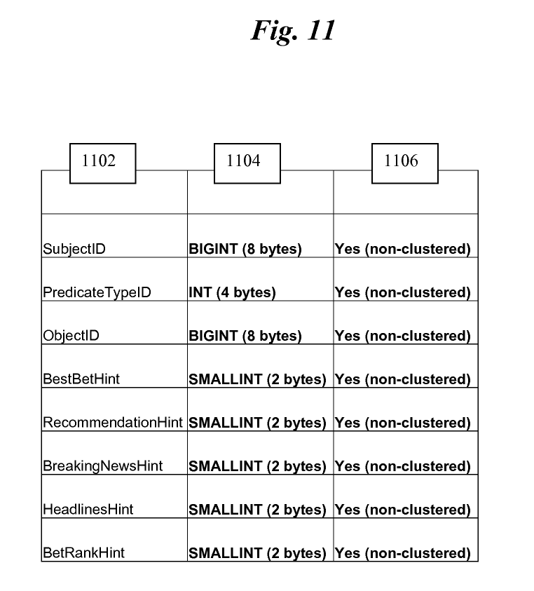

FIG. 11 is a composite index table model, in accordance with an embodiment of the invention. In one embodiment, the composite index table includes the fields listed under the column name 1102. The field names under the column name 1102 may be changed, added, or removed and still be within the teachings of this invention. Each field listed under column name 1102 may have a corresponding data type listed in the data type column 1104. The examples provided in the data type column 1104 may be deviated from and still be within the scope of this invention. Each field listed under column name 1102 may be indexed as indicated in the indexed column 1106. However, other fields listed under column name 1102 may be indexed and fields shown as indexed in the indexed column 1106 may be non-indexed.

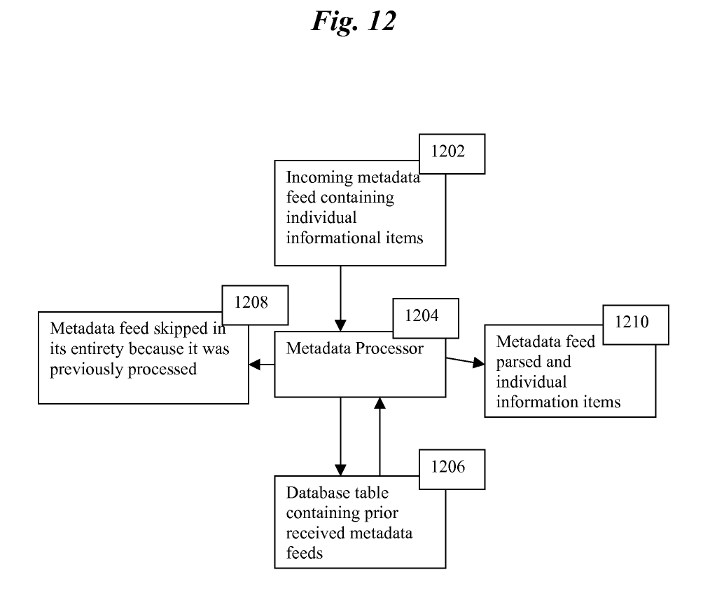

FIG. 12 is a block diagram for a method of quickly indexing data contained in a metadata feed, in accordance with an embodiment of the invention. In one embodiment of the invention, a metadata processor 1204 accepts an incoming metadata feed 1202 that contains individual informational items. The metadata feed 1202 may be an RSS feed. The metadata processor 1204 then queries a database 1206 to determine whether the metadata feed 1202 had been previously processed. In one embodiment, the metadata feed 1202 is identifiable and stored in the database 1206 by its URI. However, the metadata feed could be identified and stored using a different identifier. If the query indicates that the metadata feed 1202 had been previously processed, the metadata processor 1204 skips the metadata feed 1202 in its entirety at block 1208. However, if the query indicates that the metadata feed had not been previously processed, the metadata processor 1204 then parses the individual items of the metadata feed 1202 and records the information at block 1210. The metadata processor 1204 then updates the database 1206 to indicate that the metadata feed 1202 has been processed.

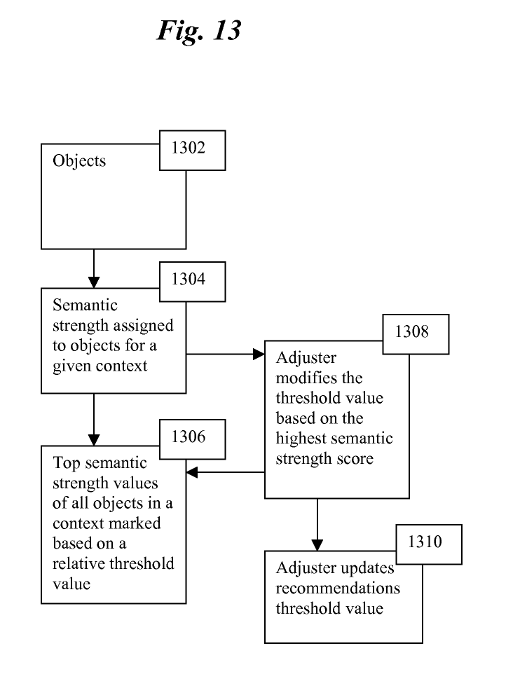

FIG. 13 is a block diagram for a method of adjusting threshold values that are used to determine the most relevant objects in a given context, in accordance with an embodiment of the invention. In one embodiment, objects at block 1302 are collected (e.g., documents). Semantic strength values are assigned to each of these objects for a given context at block 1304 by the semantic inference engine discussed in prior applications. Thus, at block 1304 there is a collection of objects with associated semantic strength values. The objects with the highest semantic strength values are marked as best bets at block 1306 if their value exceeds a given threshold value. In one embodiment, the threshold value may be all documents greater than 90% of the value of the highest ranked document. Thus, in this embodiment, the threshold value is a relative value. This value could be adjusted, or it could be absolute, or relative to any other metric, or combinations of metrics as desired. As additional objects are then added and collected at block 1302, they are also assigned semantic strength values at block 1304. The added objects may render the old threshold value obsolete given that some of the newly added objects may possess a higher semantic strength value higher than the highest previous semantic strength value. Thus, the addition of new objects with semantic strength values trigger an adjuster at block 1308. However, the adjuster 1308 could be set to run on a periodic timer or manually triggered. The adjuster at block 1308 determines the new highest semantic value of a given set of objects and adjusts the threshold value to be used at block 1306 accordingly. Furthermore, the adjuster updates other threshold values at block 1310, including values in multiple tables or databases. In one embodiment, recommendations are objects that have a semantic strength value above another threshold value calculated from the best bets threshold value. Thus, in this embodiment, the adjuster adjusts the recommendations threshold value at block 1310 as the underlying best bet threshold value changed. In a further embodiment of the invention, the adjuster at block 1308 operates when the total number of best bet objects exceeds a given percentage of total objects. In one embodiment, this percentage is 1%.

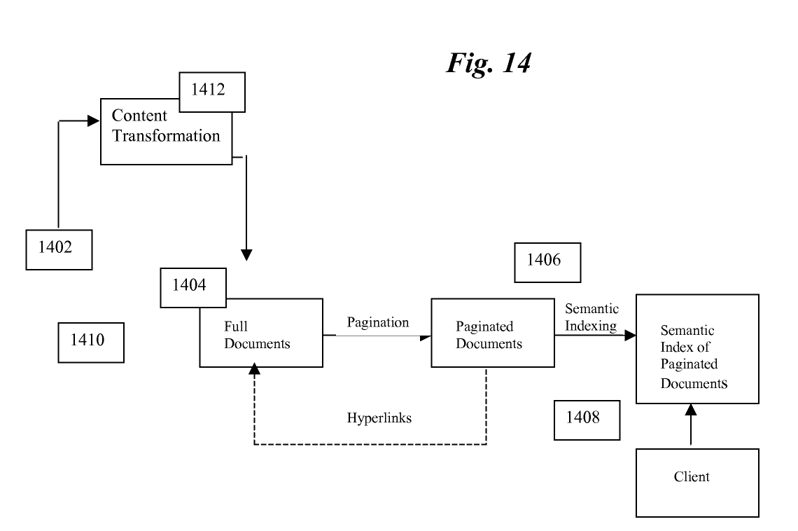

FIG. 14 is a method for indexing and retrieving semantically relevant documents, in accordance with an embodiment of the invention. In one embodiment, a full document at block 1402 is paginated into individual page documents at block 1404. A full document may be parsed according to sections, chapters, the alphabet, or any other similar or different methodology, or any combination of methods. In another embodiment, the paginated documents at block 1404 is semantically indexed at block 1406. Accordingly, a single document may be subdivided into many subparts whereby one or more, or preferably all of each of these subparts is semantically indexed. In a further embodiment, a client semantically searches and retrieves only the paginated subparts of a document at block 1408. Alternatively, a client semantically searches and retrieves, either separately or in combination, the original full document at block 1408. In this manner, a client is presented only the semantically relevant portions of particular document at block 1408. In an additional embodiment, each paginated subpart document has a link that presents the original document from which the paginated document originated at block 1410. In one embodiment, this link is a hyperlink.

In yet a further embodiment, incoming documents or other information are also submitted for content transformation at block 1412. Examples of content transformation include converting images to text data, language translation, or content cleansing by removing advertisements or other information. In one embodiment the image to text conversion is achieved using Optical Character Recognition (OCR). Accordingly, an image may be converted to text data, an English essay may be converted to French, or advertisements may be removed from a newspaper article. In another embodiment, the content transformation may be linked together. Accordingly image data may be converted to English text data that may then be converted to French whereby advertisements may be removed. The foregoing examples of content transformation may be expanded to cover any other form of content transformation. The content transformation may occur before, after, in addition to, or in lieu of the process of parsing the entire document into subparts at block 1404. In one embodiment, the content transformation at block 1412 occurs prior to the parsing of the document into subparts at block 1404. Accordingly, in one embodiment a full document, subparts of a document, content transformed full documents, or content transformed subparts of a document are separately semantically indexed. Each of these materials may be searched and displayed independently or in combination on the client at block 1408. Additionally, each of these materials may include a link 1410 to any other related document, including a link to the original full document. In yet a further embodiment, the transformations result in a metadata feed (e.g., an RSS feed) that is appropriately interpreted by the semantic indexing system at block 1406.

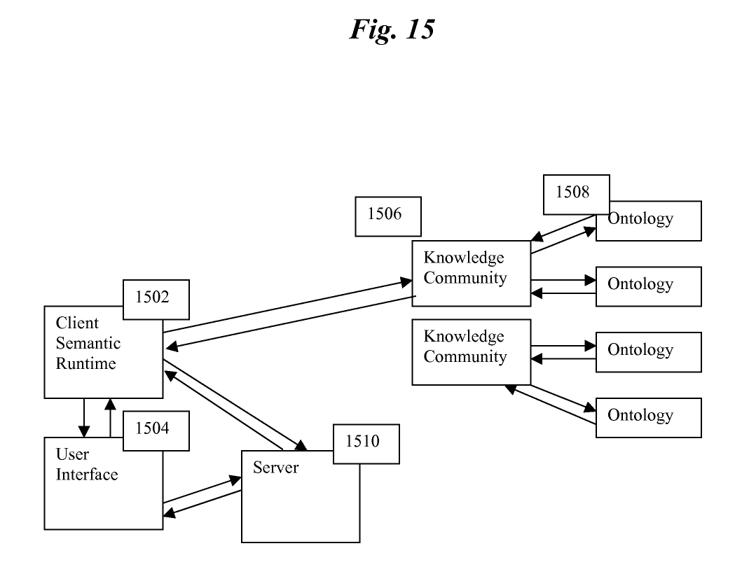

FIG. 15 is a method for highlighting semantically relevant keywords in displayed documents resulting from semantic searches, in accordance with an embodiment of the invention. In one embodiment, the client semantic runtime 1502 caches an ontology 1508 copy on the client computer for each knowledge community 1506 that a client user interface 1504 subscribes to. The copy may be an XML document representative of the data in an ontology that may be parsed using XPATH. The copy may also be a set of hash tables that include the terms of an ontology. Also, the copy may be stored to a client computer disk and lazily cached to memory only when necessary. In another embodiment, the server 1510 replicates the procedures of the client semantic runtime 1502 and stores a copy of each ontology 1508 for each knowledge community 1506. In yet another embodiment, the client semantic runtime 1502 downloads a copy of an ontology by requesting the locations of the ontologies 1508 directly from a knowledge community 1506. The ontology 1508 is downloaded via a communication protocol such as HTTP by invoking a dynamically constructed URI that points to the location of the ontology 1508 data. The client semantic runtime 1502 creates the URI by extracting concepts; passing the concepts to the knowledge community 1506 or server 1510; and obtaining URIs of relevant ontologies 1508. In a further embodiment where ontologies 1508 are not directly accessible from a client semantic runtime 1502 a copy of the ontology 1508 is obtained directly from a knowledge community 1506 or a server 1510. In a further embodiment, the client semantic runtime 1502 accepts input (e.g., via an exposed API) from the user interface 1504, searches the cached ontology data based on the input, and returns output containing relevant terms. The input may be comprised of the source URI of the information displayed in the user interface 1504 and the semantic search terms used to generate the displayed information. The output may consist of relevant terms that may be highlighted in the information displayed in the user interface 1504. These relevant terms may be those words, categories, or other items of information that are semantically relevant to the semantic search that was responsible for the information displayed in the user interface 1504. The relevant terms may be returned as part of an XML document. The XML document may also contain additional data to describe the terms or for other purposes. Additionally, the relevant terms may include the semantic search terms submitted at the client user interface 1504. In one embodiment, the search for relevant terms by the client semantic runtime 1502 is independent of the search for semantic relevant documents conducted by the server 1510. Alternatively, the search for relevant terms by the client semantic runtime 1502 may be conducted by acquiring the key concepts of the information displayed in the user interface 1504; determining the key concepts that match a user's semantic search request; and searching the cached ontology based thereon. Accordingly, in one embodiment when a semantic query or request is launched in the user interface 1504, the client semantic runtime 1502 may use this request to return relevant terms and highlight the terms in the displayed document in the user interface 1504. In yet a further embodiment, the client semantic runtime 1502 ontology cache data is updated periodically as information in the original ontology 1508 changes. This update may occur as the user subscribes to a new ontology, unsubscribes from an ontology, or when an ontology indicates that it has been updated. Other cache copies of ontologies 1508, such as those on the server 1510 or knowledge community 1506, may also be similarly updated if necessary. In additional embodiments, other updates to the client semantic runtime 1502 may include updates to the search tools (e.g., XpathDocuments, XMLTextReaders, ontology 1508 file sizes, ontology 1508 last modified file time, or file paths). In another embodiment, the client semantic runtime manages memory usage for large ontology copies by only caching copies if there is available memory. (e.g., if the copy is larger than 16 MB the available memory must be greater than 512 MB or if the copy is between 8 MB and 16 MB the available memory must be greater than 256 MB or if the copy is less than 8 MB the available memory must be greater than 128 MB).

In one embodiment, the information server used to catalog semantically marked up documents uses parallel indexing and I/O, rather than serialized indexing and I/O, so that the information server is able to index some documents while prevented from indexing other documents.

In another embodiment, the information server used to catalog semantically marked up documents removes redundant or unused indexes.

In yet another embodiment, the information server used to catalog and retrieve semantically marked up documents folds all calls to a single knowledge domain for multiple ontologies into a single call.

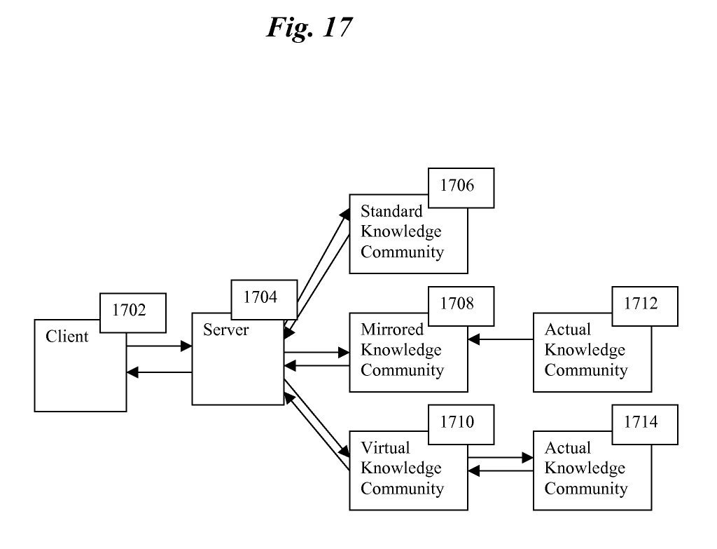

FIG. 17 is a block diagram showing methods for creating and managing multiple types of knowledge communities, in accordance with an embodiment of the invention. In one embodiment, client 1702 is in communication with server 1704. Server 1704 is in communication with multiple knowledge communities 1706, 1708, 1710. Standard knowledge community 1706 contains ontology data. Mirrored knowledge community 1708 also contains ontology data. However, in this embodiment, the ontology data is merely a copy of ontology data originating from the actual knowledge community 1712. In this embodiment, the updates to the copy may be periodic, automatic, or manual (e.g., every minute, hour, day, week, or never). Accordingly, a division of labor is achieved between certain knowledge communities (e.g., knowledge communities dedicated to indexing). Virtual knowledge community 1710 may not contain ontology data. Instead, virtual knowledge community 1710 redirects communications between the server 1704 and the actual knowledge community 1714. The communication brokering between the virtual knowledge community 1710 and the actual knowledge community 1714 is transparent to the client 1702. In an alternative embodiment, actual knowledge communities such as 1712 or 1714 are invisible to the client 1702.

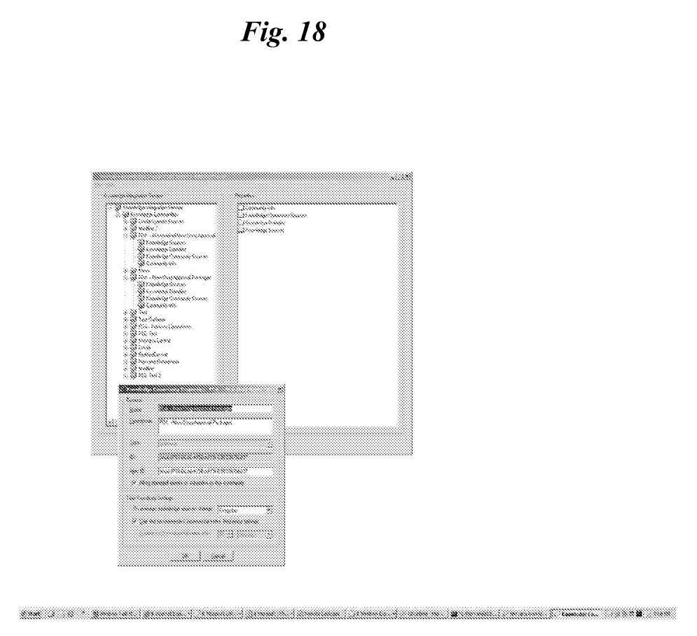

FIG. 18 is a screen shot showing a possible implementation of the embodiment shown in FIG. 17 and described above.

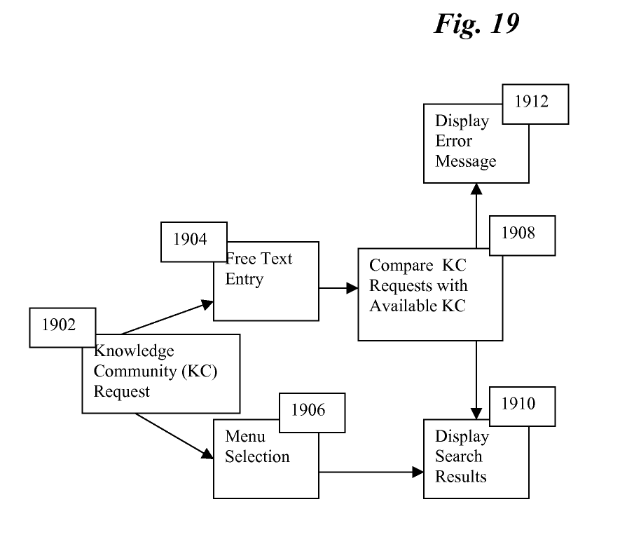

FIG. 19 is a block diagram of a method for providing user feedback on the available knowledge communities, in accordance with an embodiment of the invention. In this embodiment, a user makes a semantic search request involving certain knowledge communities at block 1902. The search request is made via a free-text entry at block 1904 or via a menu selection at block 1906. If the user enters a text request for a knowledge community at block 1904, the system compares the input knowledge community request with the available knowledge communities at block 1908. If there is at least one matching knowledge community, the system displays the desired search results at block 1910. If there is not at least one available knowledge community at block 1908, the invention displays an error message at block 1912. Alternatively, if the user makes a selection of a knowledge community from a system supplied selection (e.g., a menu), the system simply displays the results without verifying that the knowledge community is available at block 1910. However, the system could also check for the availability of the selection at block 1908.

In another embodiment, the error messages are displayed in a field. In yet another embodiment, the error messages are displayed using an icon. In a further embodiment, different messages or icons are presented depending upon whether the search request was at least partially successful. In an alternative embodiment, the error message is expanded to display details on the error.

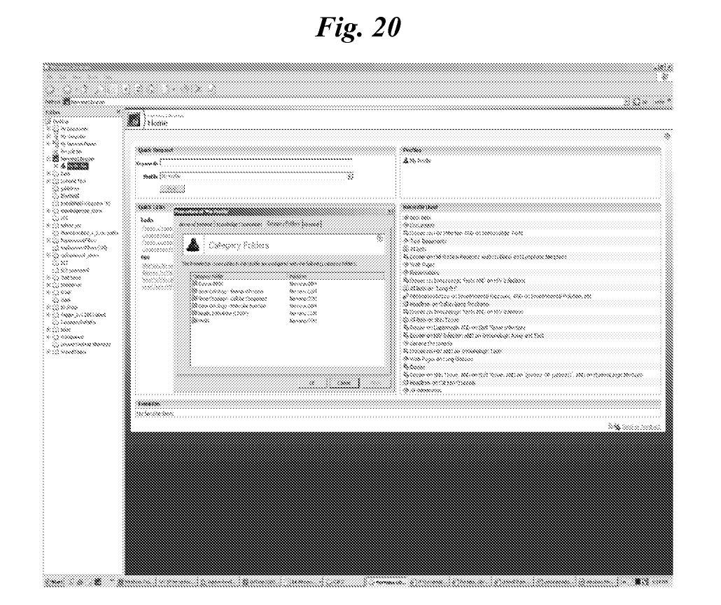

FIG. 20 is a screen shot showing a possible implementation of the embodiment shown in FIG. 19 and described above.

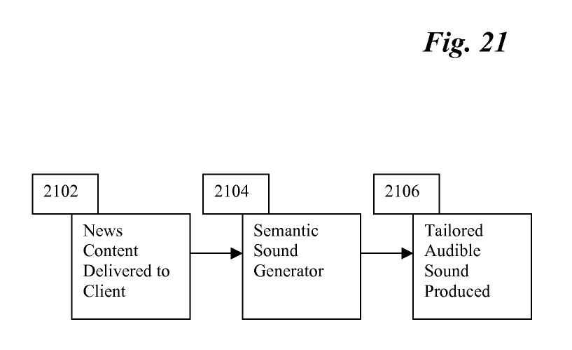

FIG. 21 illustrates a method of using semantic sounds to notify a user regarding the arrival of news in accordance with an embodiment of the invention. In this embodiment, news content is delivered to a client computer at block 2102. The semantic sound generator analyzes this incoming news to determine the content at block 2104. The semantic sound generator then produces audible sound that is tailored to the incoming news content and is intelligently based on the semantics of the news content at block 2106.

In another embodiment, audio or visual cues are presented by the semantic sound generator at block 2104. Examples of the tailoring of audible sounds at block 2106 include, but are not limited to, changing the volume, altering the pitch, or varying the type. (e.g., the more recent and important the news the higher the volume, the longer the duration since the last delivered news the higher the volume, news on aerospace results in sounds imitating airplanes, news in telecommunications results in sounds imitating phone ringers, or news on healthcare results in sounds imitating a heartbeat). In an alternative embodiment, the semantic sounds generated are customized by a user.

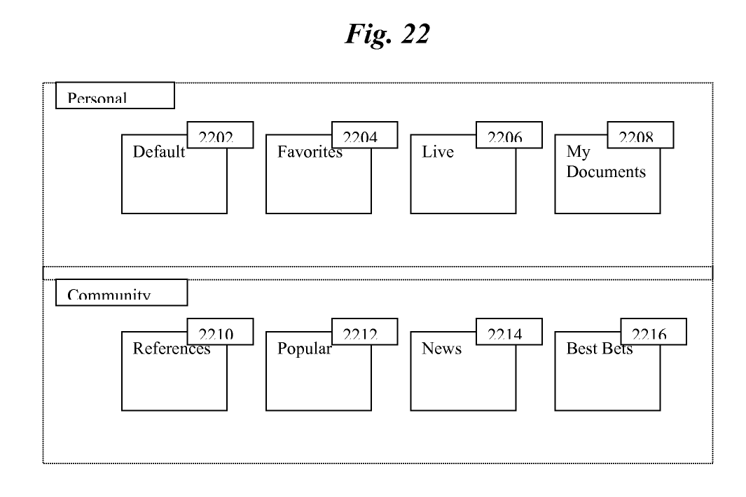

FIG. 22 is a method of tracking and presenting multiple lists of categories to a client user as the categories evolve over time, in accordance with an embodiment of the invention. The lists of categories may be separated by personal lists of categories and community lists of categories. Accordingly, the personal lists may be unavailable to other users and the community lists may be available to other users. The personal lists may be further divided into a default list 2202, a favorites list 2204, a live list 2206, or a my documents list 2208. Various types of division or naming schemes may be fashioned. In this embodiment, the default list 2202 may include those categories specifically requested by a client user. The favorites list 2204 may include those categories that relate to a client-users favorites list. The live list 2206 may include the categories embodied in other lists set to dynamically update. The my documents list 2208 may include those categories that relate to a client user's local information (e.g., local file names, email messages, web browser favorites, or any other specified source). In one embodiment, the my documents list 2208 is established through the use of local crawling agents that periodically search local information and update the categories in the my documents list 2208 based thereon. Community lists may be provided to a client user as suggestions that the client user may be interested in. Accordingly, an information server may mine certain categories from each knowledge community and present these categories to a client user in the context of one or more profiles. These categories may be dynamically updated. The categories in the community lists may be divided into recommended categories 2210, popular categories 2212, categories in the news 2214, or best bet categories 2216. Various types of division or naming schemes may be fashioned. Also, a client user may still search all categories. Recommended categories 2210 may include those categories that are similar to those already used by a client user. Additionally, recommended categories may include those categories that are used by other client users with similar interests. Popular categories 2212 may include those categories that are most accessed within a given knowledge community. Categories in the news 2214 may include those categories that are currently in the news. Best bet categories 2216 may include those categories that correspond to the best bets within a given knowledge community.

In another embodiment, the category lists are organized in a deep information format that include expandable and retractable nodes such as profile, category list, ontology, parent category, and category. Other forms of organization may be employed. Accordingly, a user may be able to navigate between multiple nodes. In yet another embodiment, these nodes may be dragged, dropped, copied, pasted, or used with the smart lens previously disclosed.

In a further embodiment, the deep information form is applied to the contents of an entity (e.g., a meeting entity). As an example, a meeting entity may have as its contents the participants of the meeting, the topics that were discussed during the meeting, the documents that were handed out during the meeting, or any other similar contents. Accordingly, in this embodiment a user may navigate within an entity or from an entity.

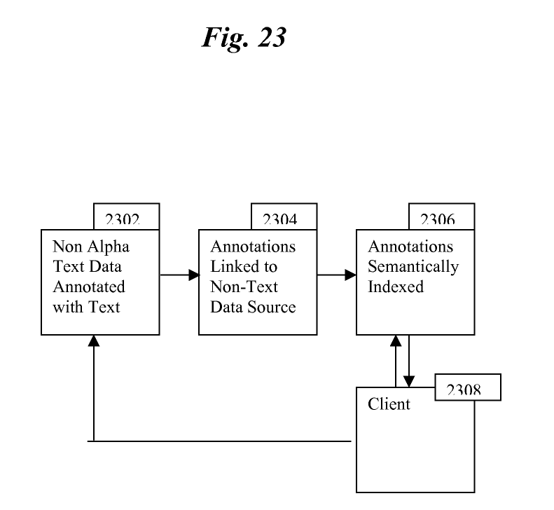

FIG. 23 is a block diagram of a method of semantically indexing and retrieving non-text data, in accordance with an embodiment of the invention. In one embodiment, non-alphabetical text data is annotated with text at block 2302. The annotations are then separated from the document and linked (e.g., via hyperlink) back to the originating document at block 2304. The annotations are then semantically indexed themselves at block 2306. A client user executes a semantic search at block 2308. The results are be interpreted by the user at the same block 2308. When a client user desires to locate the originating data from which the annotation result arose, the client user follows the link to the originating non-alphabetical text data document. In an alternative embodiment, the non-alphabetical text data is numerical, audio, video data, or any other similar data. In yet another embodiment, the non-alphabetical text data is a business report containing sales numbers, financial projections, or other similar data.

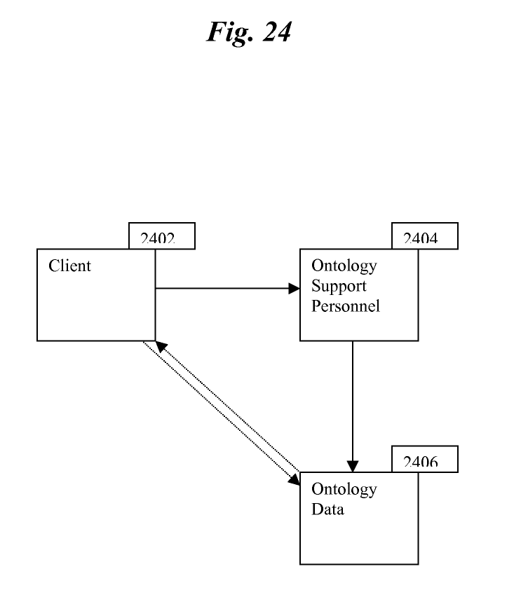

FIG. 24 is a block diagram of a method for providing ontology feedback in accordance with an embodiment of the invention. In this embodiment, a client user interacts with ontology data at block 2406. The client user then invokes a feedback request (e.g., an email form, chat room, or other communication method) to the ontology support personnel at block 2404. The ontology support personnel interprets this feedback request and makes any necessary changes to the appropriate ontology data at block 2406. In an alternative embodiment, the request information automatically populates the address, ontology name, ontology identifier, problem statement, or any other relevant field. In an alternative embodiment, a privacy statement is provided to the client user.

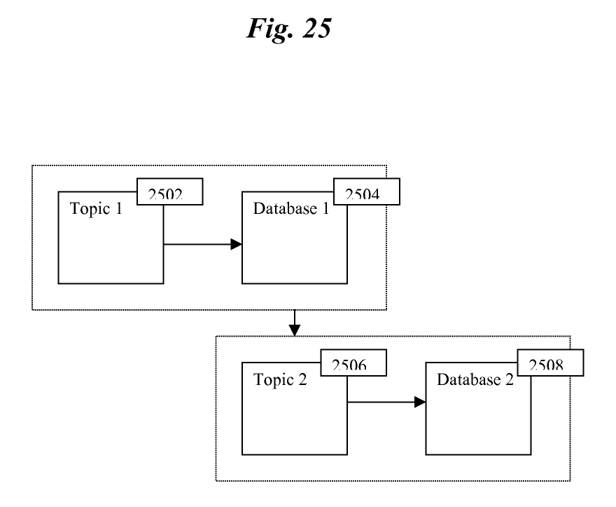

FIG. 25 is a block diagram of a method for advanced semantic searching in accordance with an embodiment of the invention. In this embodiment, a client user requests a topic one 2502 from a database one 2504 that is related to a topic two 2506 from database two 2508. For example, a client user may request all proteins from a protein database that are relevant to abstracts on a particular inhibitor molecule found in a medical database. Accordingly, a client user may link together two or more semantic searches. In an alternative embodiment, a client user instigates an advanced search by moving images representing a topic over another image representing an information source, database, a category, or context.

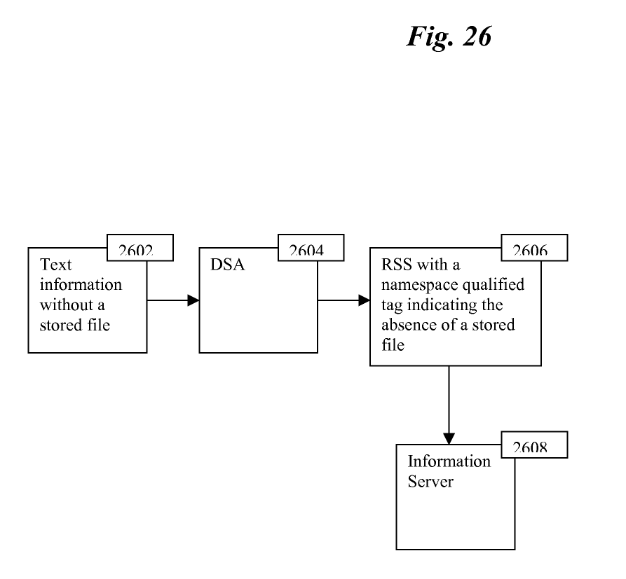

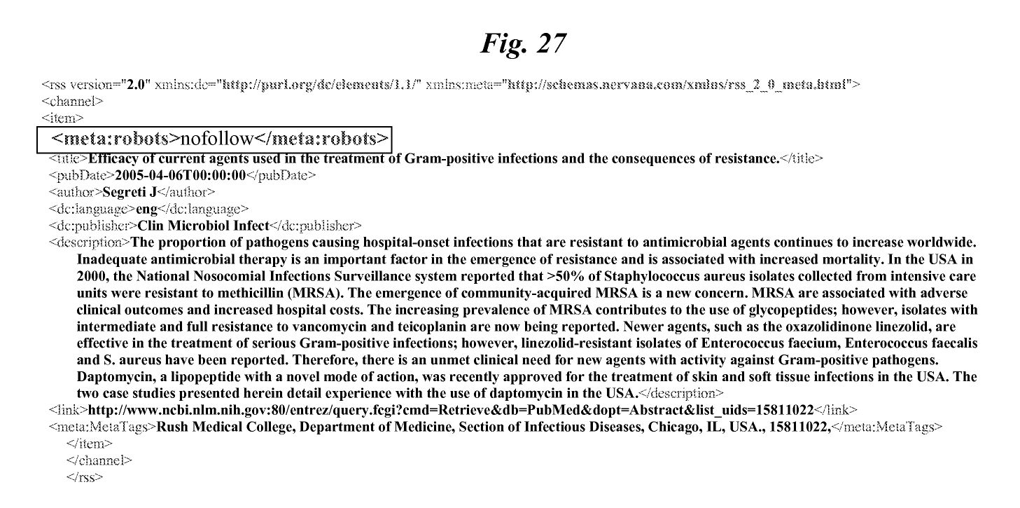

FIG. 26 is a block diagram of a method for handling floating text in an RSS feed and FIG. 27 is an example of an RSS in FIG. 26 with a namespace qualified tag indicating the absence of a stored file in accordance with an embodiment of the invention. In this embodiment, the text information without a stored file (e.g., a document) is gathered by the DSA or other similar service at block 2604. The text information without a stored file at block 2602 may be floating text or a result of an inability to index an associated file (e.g., a website may forbid crawlers from indexing website documents). The DSA then generates an RSS or other metadata feed at block 2606 with a namespace qualified tag that indicates the absence of a stored file. In one embodiment, the term “'‘nofollow” may be used as is illustrated in FIG. 27. Because of this tag, the information server and its processes may be on notice at block 2608 that the metadata does not have a stored file. Accordingly, this method may allow metadata to be indexed even if there is no associated file or the document is unable to be indexed.

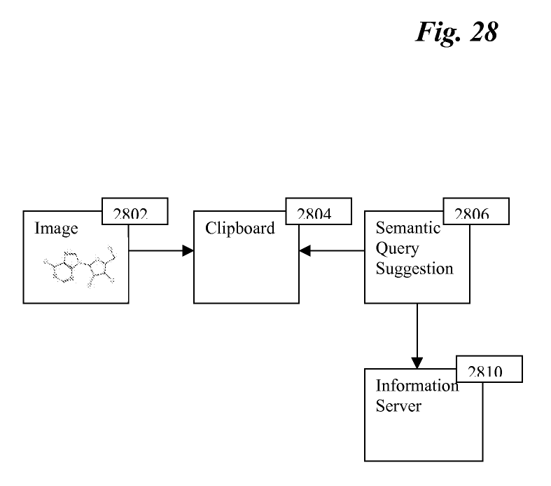

FIG. 28 is a block diagram of a method for extracting a semantic query from an image, in accordance with an embodiment of the invention. In this embodiment, an image 2802 is placed on a clipboard or other similar receptacle at block 2804. The semantic query may be created based upon the concepts that are extracted from the image at block 2806. The semantic query is submitted to the information server at block 2810. In an alternative embodiment, the data in the clipboard is any data object. In yet an alternative embodiment, the image is of a chemical compound. In this embodiment, scientific researches drag an image of a chemical compound into a clipboard whereby a semantic query is created based thereon.

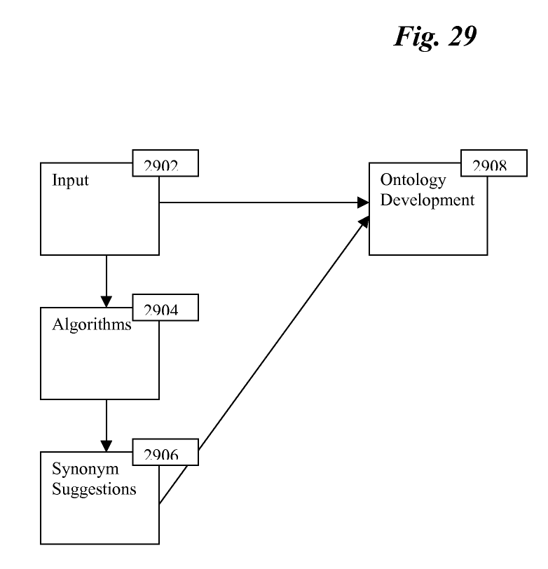

FIG. 29 is a block diagram for a method for improving ontology development in accordance with an embodiment of the invention. In this embodiment, a word is inputted into the system at block 2902. The word and its appropriate meaning are added to an ontology at block 2908. However, the word may also be subject to algorithms at block 2904. These algorithms reduce the word to its roots or correct misspelling errors. The results of the algorithm are then subjected to a synonym suggestion tool at block 2906. The word results of the synonym suggestion tool along with their associated meanings are added to an ontology at block 2908. This is demonstrated by reference to various alternative embodiments. In one embodiment, a public synonym suggestion API is utilized. In different embodiment, the synonym suggestion tool suggests slang words. In a different embodiment, the synonym suggestion tool suggests words that begin with the input phrase, contain the input phrase, or end with the input phrase. In a different embodiment, the suggestions are prioritized by any desired methodology. In a different embodiment, the root algorithm includes the following steps: call the synonym suggestion tool with the exact phrase, remove one letter, call the synonym suggestion tool with the truncated phrase, and repeat. In a different embodiment, the misspelling algorithm includes the following steps: submit the exact phrase to the suggestion tool, remove one vowel, submit the altered phrase to the suggestion tool, remove another vowel, and repeat. Alternatively, the misspelling algorithm may remove one of each double letter instance in the word and submit it to the suggestion tool. Alternatively, the misspelling algorithm may remove hyphens or add hyphens and submit the altered phrase to the suggestion tool. In yet a different embodiment, the algorithm corrects the word based on a pre-developed word list.

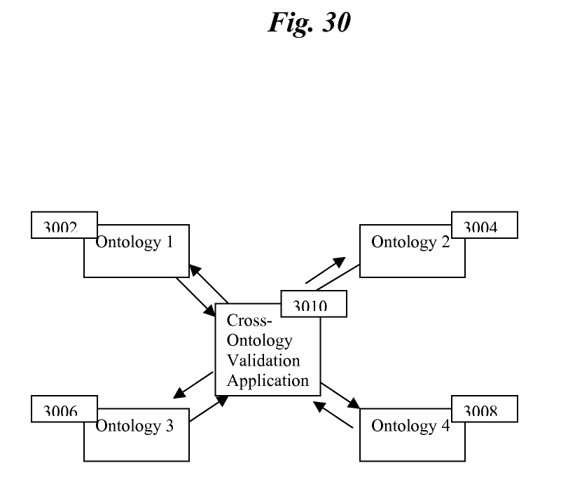

FIG. 30 is a block diagram of a method for developing and maintaining ontologies, in accordance with an embodiment of the invention. In this embodiment, a cross-ontology validation application 3008 is in communication with ontology one 3002, ontology two 3004, ontology three 3006, or ontology four 3008. The validation application 3008 is in communication with more or less than four ontologies. In an alternative embodiment, the cross-ontology validation application 3008 assists in developing and maintaining ontologies. For example, the cross ontology validation application 3008 may determine whether there are discrepancies in naming schemes between multiple ontologies and notify an ontology administrator (e.g., artificial intelligence sub-categories may be different in the IT and Products and Services ontologies. In another example, the cross-ontology validation application 3008 suggests the hooks in one domain to be exclusions for another domain and vice versa (e.g., virus in a health database should have exclusions that are themselves hooks for virus in an IT database). In an alternative embodiment, the cross-ontology validation application considers that multiple-word forms include the same exclusions or hooks.

In an alternative embodiment of the invention, the time-sensitive semantic interface engine (TSIE) is designed to return ranked newsworthy information from the recommendations based on context, time, and semantic strength.

In a different embodiment, the semantic interface engine (SIE) returns the semantic strength for a document or other similar container of information to a particular category, it's parent category, or its child categories (e.g., the semantic strength of a document to encryption may also be assigned to security as a parent of encryption). In yet another embodiment, the parent-child assignments of semantic strength are attenuated as necessary.

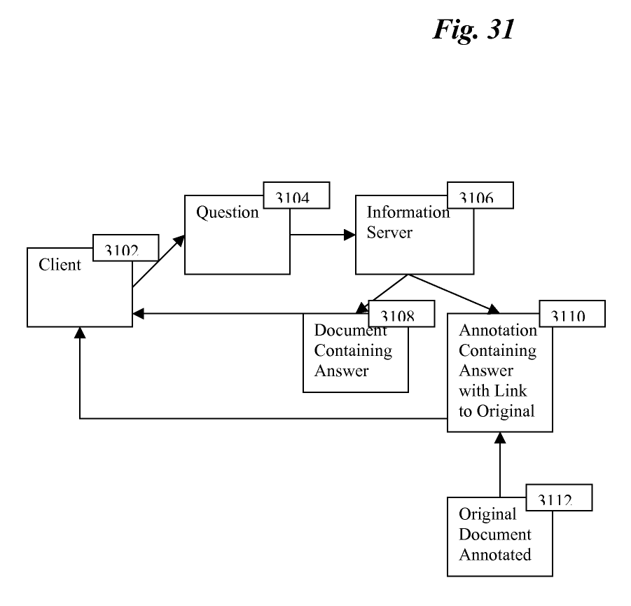

FIG. 31 is a block diagram for a method for semantic question answering in accordance with an embodiment of the invention. In this embodiment, the client user enters a question at block 3104. The question is passed to the information server at block 3106. The information server returns a document or documents that semantically answer the question at block 3108; alternatively, the information server may return an annotation or annotations that semantically answer the question at block 3110. In a different embodiment, the annotations have links (e.g., hyperlinks) back to the originating document. Accordingly, the user uses the link when viewing the annotation to obtain the full document that the annotation was based upon. In another embodiment, the annotations are annotated at block 3112 and semantically indexed to be available for retrieval at block 3110. For example, a question of the population of Norway may result in the generation of a document that describes the population of Norway somewhere in its contents. In another example, a question of the number of people that live in the second largest Scandinavian country may result in the generation of an annotation provides the answer with a link back to the originating document.

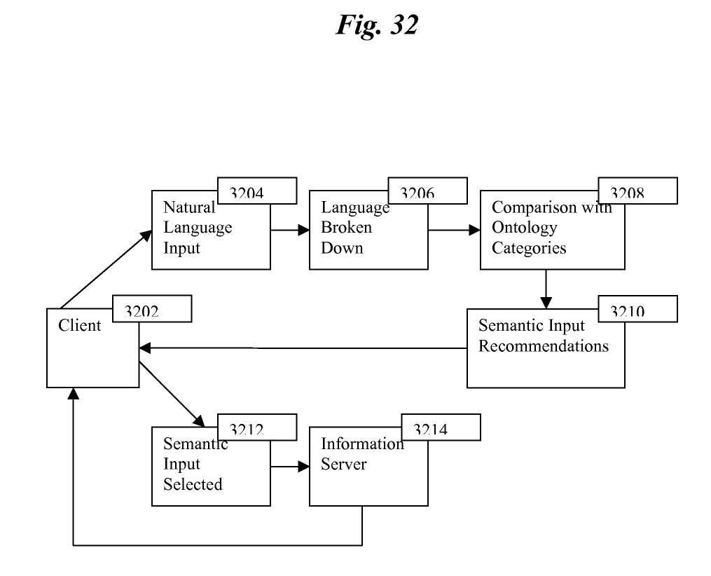

FIG. 32 is a block diagram of a method of coupling natural language with semantic language queries in accordance with an embodiment of the invention. In one embodiment, a client user inputs a natural language query at block 3204. The natural language query is then broken down into key phrases, words, or variants at block 3206. The key phrases, words, or variants are then submitted to be compared with available ontology categories at block 3208. Based on this comparison, the system presents the user with recommended search terms at block 3210. The client user may select, remove, or add to the recommended search terms at block 3202. After review, the final semantic query is then selected at block 3212 and submitted to the information server 3214 for semantic query results. Accordingly, the client user may use natural language queries to begin the process of semantic searches. In another embodiment, a client installed plug-in maps the natural language input to semantic input before passing the query to the server for interpretation; however, this may be accomplished remotely from the client. In a further embodiment, the mapped semantic input is not reviewed by the client user before being submitted to the information server. As an example, the natural language query, “develop a genetic strategy to deplete or incapacitate a disease-transmitting insect population” may result in, “diseases or disorders from a medical database and insects from a medical database and ‘transmit or transmits or transmission or transmission or transmitting. ’”

Certain embodiments of Live Mode were disclosed in one or more of applicant's prior applications listed above and are incorporated by reference herein. In one embodiment, when a Request Collection is in Live Mode some or all of its requests and entities may be presented live when the request collection is viewed. In another embodiment, the request and entities are not automatically made live themselves if they are already live. In this embodiment, only when the request collection is displayed are the requests viewed live. In yet another embodiment, a skin elects to merge the results of a Request Collection so that only one set of live results is displayed. However, in other embodiments the skins can elect to keep the individual request collection entries viewed separately in Live Mode.

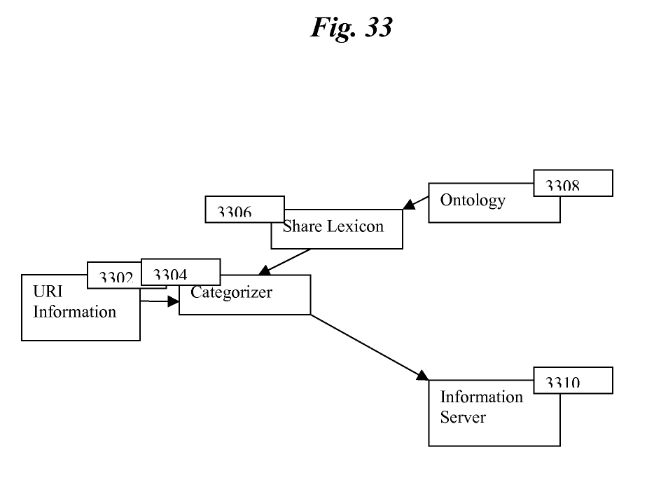

FIG. 33 is a block diagram of a method for categorizing extracted concepts from a URI, in accordance with an embodiment of the invention. In one embodiment, the ontology 3308 and the concept categorizer 3304 share the same lexicon 3306. In this regard, the information from a URI 3302 is categorized in an information server 3310 based upon lexicon 3306. Alternately, the lexicon is unique to the categorizer. In a further embodiment, when the categorizer 3304 is interpreting semantic context with non-semantic context templates (e.g., all bets, random bets) or with non-semantic ranking (e.g., bucket #0), it may map the URI information 3302 to searchable keywords. Accordingly, in this embodiment when categorization fails the URI is still retrievable via a keyword match.

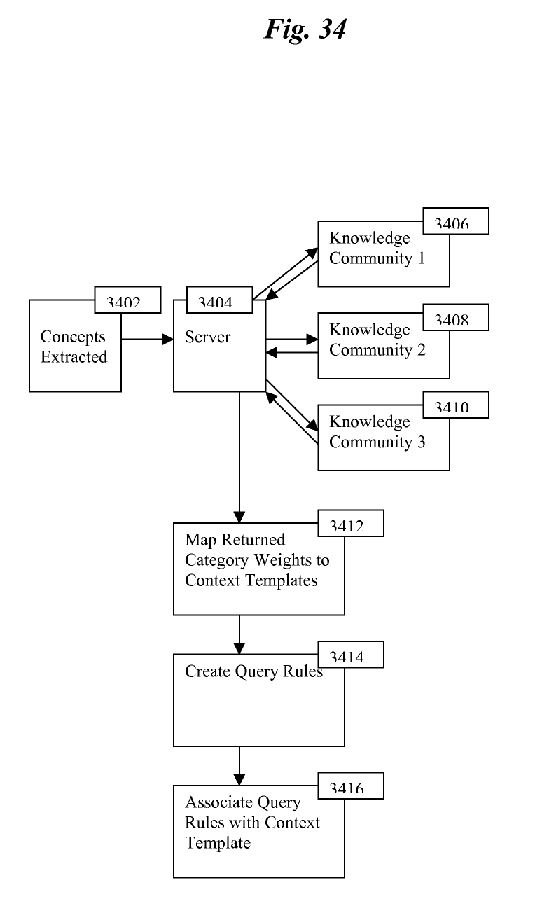

FIG. 34 is a block diagram of a method for establishing context queries, in accordance with an embodiment of the invention. In one embodiment the concepts are extracted from a data source (e.g., a document) at block 3402 and submitted to a server 3404. The server then contacts multiple knowledge communities 3406, 3408, or 3410 whereby the knowledge communities categorize and return weighted values for the extracted concepts. The number of knowledge communities may be more or less. The server then maps the returned category weight values to context templates at block 3412 (e.g., best bets, recommendations, all bets, etc.). Rules are then be created to query the context templates at block 3414 and these rules are then associated with a context template at block 3416.

In another embodiment, the concepts are passed directly, rather than through the server, to the knowledge community to be categorized and weighted. In yet another embodiment, the client has a concept extraction cache to prevent multiple concept extractions of the same data source. In a further embodiment, the server has a concept-to-category cache to prevent multiple category and weight determinations of the same concept. In one embodiment these caches are purged periodically. In another embodiment, the server cache utilizes a file access lock to prevent concurrent connection errors. Examples of query rules created at block 3414 may include, but are not limited by, the following. First, for each best bet category in the source, create a query with an “and” of all the categories. Second, for each recommendation category in the source that is not a best bet, create a query with an “and” of all the categories. Third, if first query had more than one category create N queries with each category for each best bet category in the source. Fourth, if the second Query had more than one category create N queries with each category for each recommendation category in the source. Fifth, for each best bet category in the source forward-chain by one up the hierarchy in the ontology corresponding to the category and create a query with an “and” of the parent categories (e.g., if there was a best bet on encryption then forward-chain to the parent Security in the same ontology and “and” that with the other best bet parents as well as check for and elide or eliminate duplicates as necessary when best bet categories share the same parent). In a further embodiment, forward-chaining is invoked if there are multiple unique parents. In an alternative embodiment, the threshold is increased to two for best bets. Sixth, for each recommendation category in the source that is not a best bet category apply the equivalent of query five. In one embodiment, the semantic distance threshold for forward-chaining with recommendations is 1. Seventh, for each all bets category in the source that is not a best bet or a recommendation create a query with an “and” of all the categories only if there are eventually multiple unique categories. Eight, if the source has less than a given number of keywords then add a keyword search query. In alternate embodiments, one or more of the foregoing list may be omitted, and the sequence may vary.

In one embodiment, the ontologies in the knowledge communities are also annotated with hints that indicate how the server should forward-chain to parents.

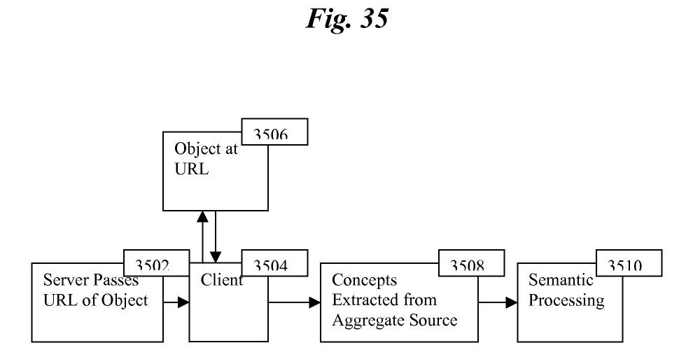

FIG. 35 is a block diagram of a method for extracting concepts from disparate sources, in accordance with an embodiment of the invention. In one embodiment, a server passes the URI of an object to a client at block 3502. The client communicates with the object located at the URI at block 3506 to obtain the metadata of the object. The concepts are extracted from the aggregate URI and object metadata at block 3508 and semantically processed at block 3510. In an alternative embodiment, the client passes the URI to an independent service that may itself gather metadata from the object located at the URI and return the object metadata to the client.

In another embodiment, the object referenced by a URI is XML. In yet another embodiment, the XML is in the SRML schema format. In a further embodiment of the independent service, the URI to the service is configured at the server or the client.

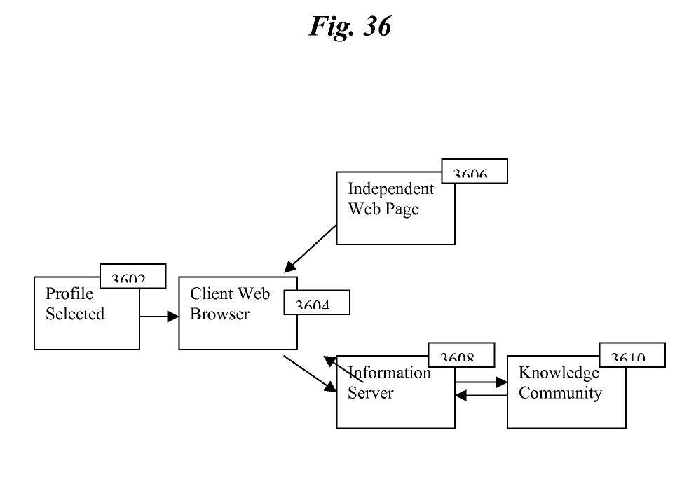

FIG. 36 is a block diagram of a method for re-organizing independent website data according to semantic strength, in accordance with an embodiment of the invention. In one embodiment, a user selects a profile at block 3602 and utilizes a client web browser at block 3604. The client web browser displays the content of an independent web page at block 3606. The content of the web page, including the links on the web page, are transmitted to the information server at block 3608. The information server queries at least one knowledge community at block 3610 to semantically rank the information from the independent website. The query results are returned to the client web browser at block 3604 whereby the independent webpage is reorganized, altered, or annotated with the semantic strength rankings of the knowledge community. Accordingly, in this embodiment of the invention web pages are dynamically reorganized or altered based on the semantic strength of their content to assist the user in more intelligently browsing.

In another embodiment, the knowledge community returns data in XML format that indicates whether an object is a best bet or recommendation. In another embodiment, the independent web page is annotated with the semantic ranking information (e.g., different colors, balloons, pop-ups, etc.).

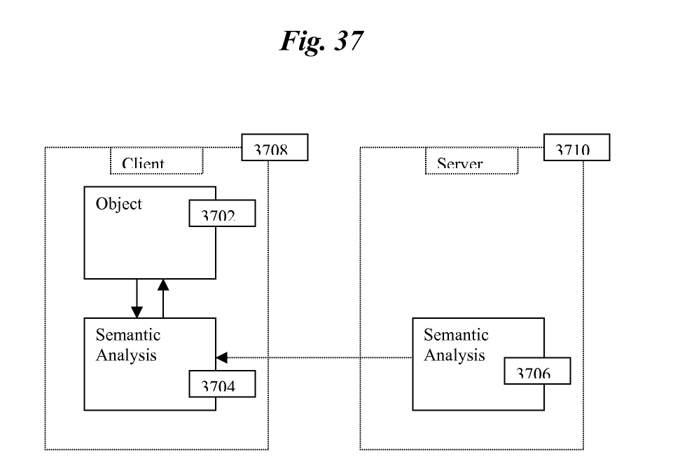

FIG. 37 is a block diagram of a method for semantic analysis on the client, in accordance with an embodiment of the invention. In one embodiment, the semantic analysis 3706 of an object 3702 is performed on the server 3710. In another embodiment, the identical semantic analysis 3704 of an object 3702 is performed on the client 3708.

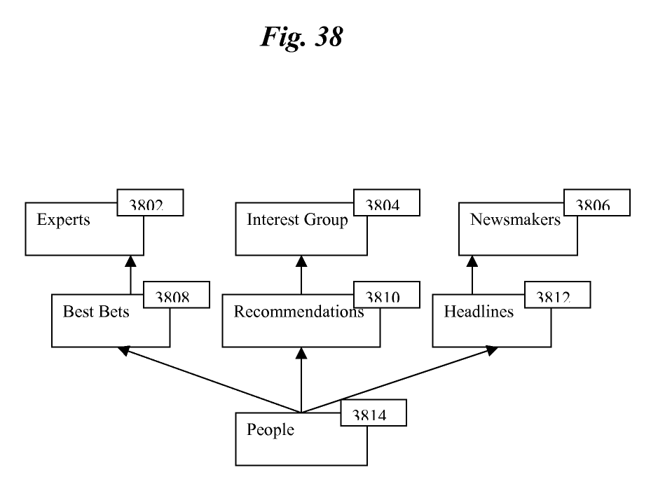

FIG. 38 is a block diagram for a method of generating information on experts, interest groups, or newsmakers, in accordance with an embodiment of the invention. In one embodiment, the experts 3802 are generated by selecting the best bets 3808 on people 3814. In another embodiment, interest groups 3804 are generated by selecting the recommendations 3810 on people 3814. In yet a another embodiment, newsmakers 3806 are generated by selecting the headlines 3812 on people 3814.

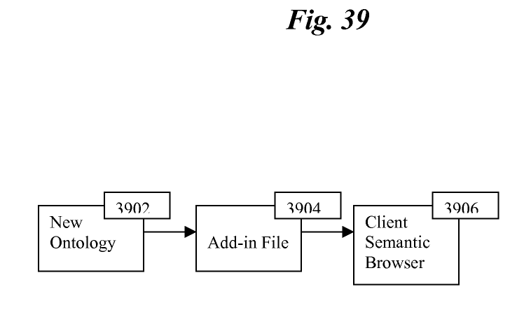

FIG. 39 is a method for adding new ontologies to a client semantic browser, in accordance with an embodiment of the invention. In one embodiment, an add-in file 3904 is added to a client semantic browser 3906. The add-in file 3904 references a new ontology 3902 that is then cached in the client semantic browser 3906. In another embodiment, the add-in file 3904 is an XML file. The XML file may contain the following fields: DomainID, KnowledgeDomain, PublisherName, Creator, CategoryFolderDescription, AreasOfInterest, TaxonomyUri, Version, or Language. In yet another embodiment, the downloaded ontology data is registered as an available knowledge source. Accordingly, new ontologies are dynamically installed or uninstalled.

In a further embodiment, the client semantic browser 3906 periodically polls a client user profile's subscribed knowledge communities to determine whether there are subscribed ontologies that are not locally installed. In an alternative embodiment, the semantic client browser 3906 alerts the user when such ontologies exist. In one embodiment, a user selects an ontology for installation.

FIG. 40 illustrates a method for using field and category specific searches to supplement keyword searches, in accordance with an embodiment of the invention. In one embodiment, a client user enters a field specific keyword search at block 4002 (e.g., Author: “Long BH”, PubYear: 2003, PubYear 2003-2005, etc.). This field specific keyword search is considered by the query processor at block 4006 whereby the input values are mapped to the appropriate query format and output at block 4008 (e.g., PREDICATETYPEID_AUTHOREDBY, PREDICATETYPEID_PUBLISHEDINYEAR). In another embodiment, a client user enters a category specific keyword search at block 4004 (e.g., Cancer: “Tyrosine Kinase Inhibitor”). The category specific keyword search may be considered by the query processor at block 4006 whereby the input values are mapped to the appropriate query format and output at block 4008.

In another embodiment, a client user specifies multiple fields or categories in the keyword search (e.g., *:Apoptosis may be to all categories). In yet another embodiment, the fields or category specifiers are combined using Boolean logic (e.g., PubYear: 1970-1975 OR PubYear: 1980-1985 OR Cancer:Tyrosine Kinase Inhibitor). (See, also, FIGS. 5 and 6 and corresponding description above).

FIG. 41 is a method for creating weighted indices and searching thereon, in accordance with an embodiment of the invention. In one embodiment, an object is gathered at block 4302 and submitted to the information server at block 4304 whereby the information server assigns a weighted index to the object that indicates the strength of the relationship between the object and a particular category. A client user at block 4310 selects an information type at block 4308 (e.g., best bet, recommendations, etc.). The information type is then mapped to the appropriate query at block 4306 to retrieve the desired objects from the information server.

In another embodiment, the weighted index range is between zero and nine. In yet another embodiment, the queries at block 4306 include those that retrieve objects with the following weighted indexes: 0-10, 1, 2, 3, 4, 5, 6-10, 7, 8, 9-10. In an alternative embodiment, the information types at block 4308 may be all bets, best bets, recommendations, breaking news, headlines, or random bets. In one embodiment, the information types are mapped to the queries at block 4306 according to the following rules: all bets are index weights 0-10, best bests are index weights 9-10, recommendations are index weights 6-10, breaking news are index weights 6-10, headlines are index weights 6-10, and random bets are 0-10. The information types and the associated index weights that they are mapped to retrieve may be altered or configured by an administrator. In one embodiment, the information types are segregated into ranking groups. For example, ranking group 0 may include only all bets; ranking group 1 may include all bets and recommendations; ranking group 2 may include best bets, recommendations, and all bets; and ranking group 3 may include all information types. In another embodiment, random bets are implemented within ranking groups. Also, it should be understood that additional ranking groups may be added and the example ranking groups may be removed or altered. In a further embodiment, the returned objects within an information type are further ranked according to the weighted index, time, or they may be randomly returned. In one embodiment, the returned object results are checked for duplicates. In another embodiment, the objects in the information types are updated because the weighted index assigned to objects is a relative value.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A system for knowledge retrieval, management, delivery and presentation, comprising:
a server programmable to maintain semantic information;
a client providing a user interface for a user to communicate with the server; and
wherein the processor of the server operates to perform the steps of:
securing information from information sources;
semantically ascertaining one or more semantic properties of the information; and
responding to user queries based upon one or more of the semantic properties.

2. The system of claim 1, wherein the first server further comprises structure or methodology directed to providing at least one of the following: a Semantic Network, a Semantic Data Gatherer, a Semantic Network Consistency Checker, an Inference Engine, a Semantic Query Processor, a Natural Language Parser, an Email Knowledge Agent, or a Knowledge Domain Manager.

3. The system of claim 1, wherein:
the information comprises objects or events; and
the semantic properties of the objects or events are represented by active agents for semantically linking to the semantics and properties of the queries.

4. A method for knowledge retrieval, management, delivery and presentation for use with a server system programmed to add, maintain and host domain specific information that is used to classify and categorize semantic information, comprising:
securing information from information sources;
semantically linking the information from the information sources;
maintaining the semantic attributes of the semantically linked information;
delivering requested semantic information based upon user queries; and presenting semantic information according to customizable user preferences.
